(19) United States
(12) Patent Application Publication
(10) Pub. No.: US 2025/0282671 A1
(43) Pub. Date: Sep. 11, 2025

(54) YTTRIUM ALUMINOSILICATE GLASS, PREPARATION METHOD, AND ELECTRONIC DEVICE

(71) Applicants: Honor Device Co., Ltd., Shenzhen (CN); Shanghai Institute of Optics and Fine Mechanics, Chinese Academy of Sciences, Shanghai (CN)

(72) Inventors: Xiaoqi JIANG, Shanghai (CN); Xin WANG, Shanghai (CN); Zhenguo SHI, Shenzhen (CN); Wenbin XU, Shenzhen (CN); Shuai HAN, Shenzhen (CN)

(73) Assignees: Honor Device Co., Ltd., Shenzhen (CN); Shanghai Institute of Optics and Fine Mechanics, Chinese Academy of Sciences, Shanghai (CN)

(21) Appl. No.: 18/862,736

(22) PCT Filed: May 4, 2023
(86) PCT No.: PCT/CN2023/092002

§ 371 Date: Nov. 4, 2024

(30) Foreign Application Priority Data
Jul. 20, 2022 (CN) 202210856670.8

(51) Int. Cl. C03C 3/068

(52) U.S. Cl. CPC C03C 3/068; C03C 2203/10; C03C 2203/52

(57) ABSTRACT

This application provides yttrium aluminosilicate glass, a preparation method, and an electronic device. For representation by a reference mole percentage of an oxide, the yttrium aluminosilicate glass specifically includes the following components: SiO₂ 20-50%; Al₂O₃ 15-40%; MgO 10-35%; Y₂O₃ 5-35%; TiO₂ 0.1-15%; ZrO₂ 0.1-15%; Na₂O 0.1-15%; L₂O 0.1-15%; K₂O 0.1-15%; B₂O₃ 0.1-10%; BaO 0.1-10%; SrO 0.1-10%; Sb₂O₃ 0.1-10%; and La₂O₃ 0.1-10%. The yttrium aluminosilicate glass provided in this application has a high glass forming capability and excellent drop resistance and mechanical properties such as Vickers hardness, Mohs hardness, and a Young's modulus.

### CROSS-REFERENCE TO RELATED APPLICATIONS

This application is a national stage of International Application No. PCT/CN2023/092002, filed on May 4, 2023, which claims priority to Chinese Patent Application No. 202210856670.8, filed on Jul. 20, 2022. The disclosures of both of the aforementioned applications are hereby incorporated by reference in their entireties.

### TECHNICAL FIELD

This application relates to the field of glass technologies, and specifically, to yttrium aluminosilicate glass, a preparation method, and an electronic device.

### BACKGROUND

With rapid development of the electronic information industry, electronic products such as mobile phones, bracelets, and tablet computers increasingly become essential for daily life. With consumers' ultimate pursuit for product appearance, sizes of displays of electronic products gradually increase, and new forms such as 3D models, foldable screens, and scroll screens emerge. Usually, a display cover plate, a rear battery cover, a camera protection cover plate, and the like of an electronic product are made of a glass material. This poses higher requirements on flexural strength, scratch resistance, and drop resistance of the glass material.

At present, aluminate glass or silicate glass is often used as the glass material. A glass former in the aluminate glass is Al₂O₃, which has a small glass forming interval, and is highly susceptible to an external additive. Consequently, undesirable phenomena such as crystallization and phase splitting occur. Although the silicate glass has excellent glass forming properties, mechanical properties are poor because a bulk density (Vᵢ), a high elastic modulus coefficient (Eᵢ), and a high specific modulus coefficient (Sᵢ) of a component of the silicate glass are low. Therefore, surface hardness, flexural strength, fracture toughness properties, and the like of the aluminate glass and the silicate glass are low, and cannot meet an actual application requirement.

### SUMMARY

This application provides yttrium aluminosilicate glass, a preparation method, and an electronic device, to resolve a problem that surface hardness, flexural strength, fracture toughness properties, and the like of aluminate glass and silicate glass are low, and cannot meet an actual application requirement.

According to a first aspect, this application provides yttrium aluminosilicate glass. For representation by a reference mole percentage of an oxide, the yttrium aluminosilicate glass includes the following components:
SiO₂ 20-50%;
Al₂O₃15-40%;
MgO 10-35%;
Y₂O₃ 5-35%;
TiO₂ 0.1-15%;
ZrO₂ 0.1-15%;
Na₂O 0.1-15%;
Li₂O 0.1-15%;
K₂O 0.1-15%;
B₂O₃ 0.1-10%;
BaO 0.1-10%;
SrO 0.1-10%;
Sb₂O₃ 0.1-10%; and
La₂O₃ 0.1-10%.

In the foregoing provided yttrium aluminosilicate glass, an oxide with a high bulk density, a high elastic modulus coefficient, and a high specific modulus coefficient is introduced into a glass system, and components and a component configuration are properly adjusted and controlled. A glass forming capability is strong, and a structure density and strength of the glass are high. This improves drop resistance and mechanical properties such as Vickers hardness, Mohs hardness, and a Young's modulus of the glass. In addition, the yttrium aluminosilicate glass has a high light transmittance in a visible light band, and may be widely used in portable and wearable electronic devices.

In an optional implementation, for representation by a reference mole percentage of an oxide, 0.3%≤Li₂O+Na₂O+K₂O≤15%.

In this implementation, the yttrium aluminosilicate glass can perform high-efficiency ion exchange chemical strengthening. This helps improve a depth of an ion exchange layer and increase deep stress, thereby improving scratch resistance and drop resistance.

In an optional implementation, for representation by a reference mole percentage of an oxide, 40%≤Al₂O₃+MgO+Y₂O₃≤60%.

In this implementation, a glass forming capability, Vickers hardness, and a Young's modulus can be improved. This helps prepare high-strength yttrium aluminosilicate glass.

In an optional implementation, for representation by a reference mole percentage of an oxide, a mole percentage of ZrO₂ is 1-15%.

In this implementation, Vickers hardness and toughness of the yttrium aluminosilicate glass can be improved, and a high visible light transmittance and high flexural strength can be maintained.

In an optional implementation, for representation by a reference mole percentage of an oxide, a mole percentage of B₂O₃ is 2-10%.

In this implementation, properties such as surface hardness, flexural strength, and fracture toughness of the glass can be improved. This helps prepare high-strength yttrium aluminosilicate glass.

In an optional implementation, a light transmittance of the yttrium aluminosilicate glass in a visible light band is greater than or equal to 88%.

In an optional implementation, a Young's modulus of the yttrium aluminosilicate glass is greater than 100 GPa.

In an optional implementation, Vickers hardness of the yttrium aluminosilicate glass is greater than 6.87 GPa.

In an optional implementation, Mohs hardness of the yttrium aluminosilicate glass is greater than or equal to 7 and less than or equal to 9.

According to a second aspect, this application provides an yttrium aluminosilicate glass preparation method, specifically including the following steps:
mixing raw materials required for meeting the yttrium aluminosilicate glass in the first aspect, to obtain a powder mixture after mixing;
melting the powder mixture for 2˜3 h at a temperature of 1400˜1600° C., and stirring the mixture evenly to obtain molten glass;
pouring the molten glass into a preheated mold for molding, to obtain a glass former;
and after heat preservation is performed on the glass former for 3˜5 h at a temperature of 650˜850° C., cooling down to an indoor temperature at a preset rate to obtain the yttrium aluminosilicate glass.

According to the foregoing provided yttrium aluminosilicate glass preparation method, based on a silicate system, oxides with high bulk densities, high elastic modulus coefficients, and high specific modulus coefficients are introduced. Components and a component configuration are properly adjusted and controlled, so that the manufactured yttrium aluminosilicate glass has a high transmittance, and mechanical properties such as surface hardness, fracture strength, and fracture toughness of the glass are improved. In addition, a preparation process is simple, costs are low, and application to industrial production is easy.

In an optional implementation, a temperature of the mold is 500˜600° C.

In an optional implementation, the preset rate is 1˜10° C./h.

In an optional implementation, for representation by a mass ratio of the yttrium aluminosilicate glass, the raw materials include: 9.08 g SiO₂, 24.46 g Al₂O₃, 8.06 g MgO, 22.57 g Y₂O₃, 2.00 g TiO₂, 4.31 g ZrO₂, 6.36 g Na₂CO₃, 1.48 g Li₂CO₃, 0.69 g K₂CO₃, 1.79 g H₃BO₃, 1.38 g BaCO₃, 0.15 g SrCO₃, 0.33 g La₂O₃, and 0.29 g Sb₂O₃.

In an optional implementation, the method specifically includes the following steps:
mixing the raw materials, to obtain a powder mixture after mixing;
melting the powder mixture for 2 h at a temperature of 1560° C., and stirring the mixture evenly to obtain molten glass;
pouring the molten glass into the mold that has been preheated to a temperature of 550° C. for molding, to obtain a glass former; and
after heat preservation is performed on the glass former for 2 h at a temperature of 720° C., cooling down to an indoor temperature at a preset rate of 5° C./h to obtain the yttrium aluminosilicate glass.

In an optional implementation, this application provides application of the yttrium aluminosilicate glass in an electronic device, a building material, and transportation equipment.

The yttrium aluminosilicate glass provided in this application is not only applicable to electronic devices, but also applicable to fields such as transportation and building. The yttrium aluminosilicate glass may be specifically used for protection glass in fields such as transportation vehicles, household appliances, and building, for example, protection glass of a display or a meter protection cover.

According to a third aspect, this application provides an electronic device, including a display cover plate. The display cover plate uses the yttrium aluminosilicate glass in the first aspect.

In an optional implementation, the electronic device further includes a rear battery cover, and the rear battery cover uses the yttrium aluminosilicate glass in the first aspect.

In an optional implementation, the electronic device further includes a camera component and a camera protection cover plate, the camera protection cover plate covers the camera component, and the camera protection cover plate uses the yttrium aluminosilicate glass in the first aspect.

In an implementation provided in this application, one or more of the display cover plate, the rear battery cover, and the camera protection cover plate of the electronic device provided in this application may use the foregoing yttrium aluminosilicate glass.

### BRIEF DESCRIPTION OF DRAWINGS

To describe technical solutions of this application more clearly, the following briefly describes accompanying drawings used in embodiments. It is clear that a person of ordinary skill in the art may still derive other accompanying drawings from these accompanying drawings without creative efforts.

FIG. 1 is a diagram of a structure of an electronic device according to an embodiment of this application;

FIG. 2 is a diagram of property comparison between aluminate glass, silicate glass, and yttrium aluminosilicate glass according to an embodiment of this application;

FIG. 3 is a schematic flowchart of an yttrium aluminosilicate glass preparation method according to an embodiment of this application;

FIG. 4 shows light transmittance curves of yttrium aluminosilicate glass according to Embodiment 2, Embodiment 4, and Embodiment 6 of this application;

FIG. 5 is a diagram of a test on Vickers hardness of yttrium aluminosilicate glass according to Embodiment 7 of this application; and

FIG. 6 is a micrograph of Mohs hardness-based scratches on yttrium aluminosilicate glass according to Embodiment 1 and Embodiment 6 of this application.

### DESCRIPTION OF EMBODIMENTS

To make the technical solutions of this application more comprehensible for a person skilled in the art, the following clearly and completely describes the technical solutions in embodiments of this application with reference to the accompanying drawings in embodiments of this application. It is clear that the described embodiments are merely some rather than all of embodiments of this application. Based on embodiments of this application, all other embodiments obtained by a person of ordinary skill in the art without creative efforts shall fall within the protection scope of this application.

An electronic device 100 in embodiments of this application may be an electronic device that includes a glass material, for example, a mobile phone, a vehicle-mounted device (also referred to as an on-board unit), a tablet computer, a notebook computer, an ultra-mobile personal computer (UMPC), a handheld computer, a netbook, a personal digital assistant (PDA), a wearable electronic device, or a virtual reality device. This is not limited in embodiments of this application.

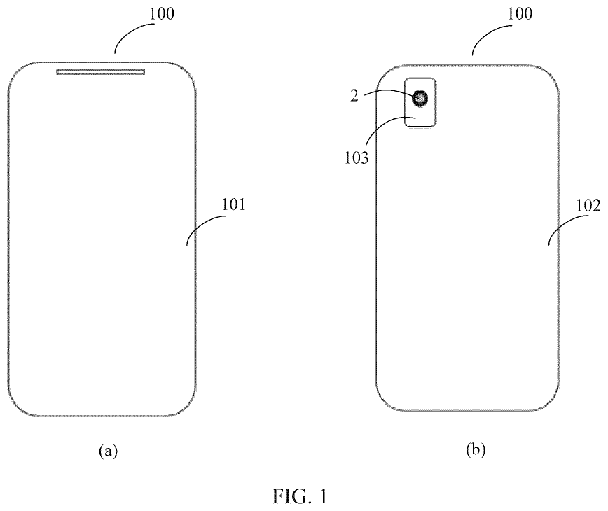

Using a mobile phone as an example of the foregoing electronic device 100, a in FIG. 1 is a front view of the mobile phone. Refer to FIG. 1. The electronic device 100 includes a display cover plate 101 on a front side. b in FIG. 1 is a rear view of the mobile phone. Still refer to FIG. 1. The electronic device 100 further includes a rear battery cover 102 on a rear side. The display cover plate 101 covers a display panel, to isolate and protect the display panel, so as to avoid damage to the display panel caused by an external thing or force. The display panel is configured to display an image, a video, and the like. The display panel may be a liquid crystal display (LCD), an organic light-emitting diode (OLED), an active-matrix organic light-emitting diode (AMOLED), a flexible light-emitting diode (FLED), a Miniled, a MicroLed, a Micro-oLed, a quantum dot light-emitting diode (QLED), or the like.

The display cover plate 101 and/or the rear battery cover 102 are/is made of yttrium aluminosilicate glass, and are/is transparent in a visible light band. The yttrium aluminosilicate glass provided in this application has good properties such as hardness, flexural strength, and fracture toughness, and improved properties such as scratch resistance and drop resistance. Therefore, the yttrium aluminosilicate glass is less likely to be damaged. In addition, the display cover plate 101 has a high light transmittance, and therefore does not affect use of the display panel below the display cover plate. It should be noted that the display cover plate 101 and the rear battery cover 102 may be completely made of the yttrium aluminosilicate glass, or may be partially made of the yttrium aluminosilicate glass.

The electronic device 100 may further include other necessary components such as a processor, an external memory interface, an internal memory, a universal serial bus (USB) interface, a charging management module, a power management module, a battery, an antenna, a mobile communication module, a wireless communication module, an audio module, a speaker, a receiver, a microphone, a headset jack, a sensor module, a button, a motor, an indicator, and a camera.

In some implementations of this application, still referring to b in FIG. 1, the electronic device 100 further includes a camera component 2 and a camera protection cover plate 103. The camera protection cover plate 103 covers the camera component 2, and the camera protection cover plate 103 may be made of the yttrium aluminosilicate glass. It should be noted that the camera protection cover plate 103 may be partially made of the yttrium aluminosilicate glass, or may be completely made of the yttrium aluminosilicate glass.

In some implementations of this application, a disposing position of the camera protection cover plate 103 may be determined based on a disposing position of the camera component 2. For example, the camera protection cover plate may be located on a front side of the electronic device 100, or may be located on a rear side of the electronic device 100. In addition, the camera protection cover plate 103 may be disposed in an appropriate position on the front side or the rear side of the electronic device 100. This depends on a position of the camera component 2 in the electronic device 100.

In some implementations of this application, the camera protection cover plate 103 may be separated from the display cover plate 101 or the rear battery cover 102. Alternatively, the camera protection cover plate may be integrated with the display cover plate 101 or the rear battery cover 102.

In some implementations of this application, any one, any two, or all of the display cover plate 101, the rear battery cover 102, and the camera protection cover plate 103 in the electronic device 100 may be made of the yttrium aluminosilicate glass. The yttrium aluminosilicate glass provided in this application has a high light transmittance and excellent mechanical properties such as Vickers hardness, Mohs hardness, and a Young's modulus, can improve reliability of an electronic device product, and can meet optical requirements of display and photographing of the display cover plate and the camera protection cover plate.

The yttrium aluminosilicate glass provided in this application is further described below.

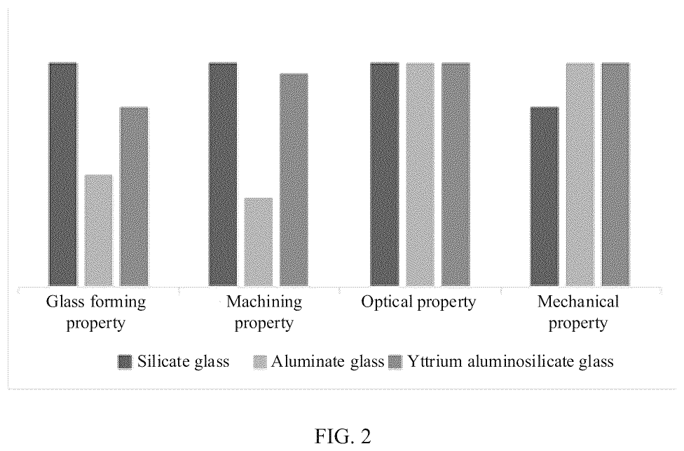

Refer to FIG. 2. Currently, a glass material commonly used in an electronic device is aluminate glass or silicate glass. A glass former in the aluminate glass is Al₂O₃, which has a small glass forming interval and a low machining property, and is highly susceptible to an external additive. Consequently, undesirable phenomena such as crystallization and phase splitting occur. Although the silicate glass has excellent glass forming properties, mechanical properties are poor because a bulk density (Vᵢ), a high elastic modulus coefficient (Eᵢ), and a high specific modulus coefficient (Sᵢ) of a component of the silicate glass are low. Based on a silicate glass system, oxides with high bulk densities, high elastic modulus coefficients, and high specific modulus coefficients are introduced into the yttrium aluminosilicate glass provided in this application. Mechanical properties such as Vickers hardness, Mohs hardness, and a Young's modulus are improved by properly adjusting and controlling components and a component configuration, so that high-strength yttrium aluminosilicate glass is obtained.

In some implementations of this application, for representation by a reference mole percentage of an oxide, the yttrium aluminosilicate glass specifically includes the following components: SiO₂ 20-50%; Al₂O₃15-40%; MgO 10-35%; Y₂O₃ 5-35%; TiO₂ 0.1-15%; ZrO₂ 0.1-15%; Na₂O 0.1-15%; Li₂O 0.1-15%; K₂O 0.1-15%; B₂O₃ 0.1-10%; BaO 0.1-10%; SrO 0.1-10%; Sb₂O₃ 0.1-10%; and La₂O₃ 0.1-10%.

In this application, a relationship between the components in the yttrium aluminosilicate glass is controlled, and in particular, a relationship between Li₂O, Na₂O, K₂O, ZrO₂, and B₂O₃ is controlled, to perform high-efficiency ion exchange chemical strengthening, so as to improve a structure density and strength of the glass, so that mechanical properties such as Vickers hardness, Mohs hardness, and a Young's modulus of the glass are improved.

In some implementations of this application, Table 1 is a schematic table of main oxide components of the foregoing yttrium aluminosilicate glass and bulk densities (Vᵢ), elastic modulus coefficients (Eᵢ), specific modulus coefficients (Sᵢ), and mole content of the main oxide components. Refer to Table 1. Oxides with high bulk densities, high elastic modulus coefficients, and high specific modulus coefficients that are introduced in this application include: MgO, TiO₂, ZrO₂, Al₂O₃, and Y₂O₃. The foregoing oxide components are introduced and properly adjusted and controlled, so that it is ensured that the yttrium aluminosilicate glass has higher Vickers hardness, higher Mohs hardness, and a higher Young's modulus, thereby reducing a penetration depth of a sharp object. In addition, a crack tip is bent and passivated, and crack work is increased, so that crack propagation is effectively suppressed. Drop resistance of the glass is further improved while the crack propagation is suppressed.

TABLE 1

| | Bulk | Elastic modulus | Specific modulus | Mole |
|---|---|---|---|---|
| | density | coefficient | coefficient (Sᵢ)/ | content |
| Component | (Vᵢ) | (Eᵢ)/(GPa/mol) | (MN m/kg mol) | mol % |
| SiO₂ | 0.541 | 73.0 | 32.8 | 20~50 |
| Al₂O₃ | 0.832 | 173.8 | 43.8 | 15~40 |
| MgO | 0.731 | 138.6 | 38.7 | 10~35 |
| Y₂O₃ | 0.865 | 237.7140 | 40.8 | 5~35 |
| TiO₂ | 0.779 | 151.2 | 35.5 | 0.1~15 |
| ZrO₂ | 0.846 | 192.2 | 32.6 | 0.1~15 |
| Na₂O | 0.410 | 30.2 | 13.3 | 0.1~15 |
| Li₂O | 0.539 | 87.4 | 43.4 | 0.1~15 |
| K₂O | 0.463 | 22.0 | 9.5 | 0.1~15 |
| B₂O₃ | 0.541 | 83.4 | 33.9 | 0.1~10 |
| BaO | 0.533 | 43.2 | 7.6 | 0.1~10 |
| SrO | 0.548 | 53.2 | 11.3 | 0.1~10 |
| La₂O₃ | 0.568 | 77.0 | 11.8 | 0.1~10 |

Specifically, in the foregoing yttrium aluminosilicate glass system, SiO₂ is used as a skeleton component of a glass network structure. Content of SiO₂ directly affects development of the network structure, and greatly affects an overall property of the glass. Higher content of SiO₂ in the glass system indicates a denser glass network structure, higher mechanical strength, a smaller thermal expansion coefficient, and better heat resistance, dielectric property, and chemical stability. However, if the content of SiO₂ is excessively high, melt viscosity of the glass is high, and glass forming is difficult. To meet a property requirement, a mole percentage of SiO₂ in the yttrium aluminosilicate glass in this application is preferably 20-50%.

Al₂O₃ is a network intermediate, and participates in network structure forming, to strengthen the network structure. In addition, introduction of Al₂O₃ increases viscosity of high-temperature molten glass, so that a material property of the glass is shortened, and forming difficulty increases. In addition, Al₂O₃ greatly affects subsequent ion exchange for the yttrium aluminosilicate glass. Therefore, when content of Al₂O₃ is excessively high, especially when the content of Al₂O₃ is higher than that of alkali metal, Al³⁺ exists as a network modifier, a coordination number increases, and the network structure tends to increase. That is, excessively high content of Al₂O₃ adversely affects an ion exchange effect. Based on this, to meet a property requirement, a mole percentage of Al₂O₃ in the yttrium aluminosilicate glass in this application is preferably 15-40%.

MgO has two coordination states in the glass, and can form a [MgO₄]tetrahedron and a [MgO₆]octahedron. Generally, most of MgO is located in the [MgO₆]octahedron and acts as a network modifier. Only when content an alkali metal oxide is high and oxides such as Al₂O₃ and B₂O₃ are not included, a Mg²⁺ ion may be located in the [MgO₄]tetrahedron. Introduction of MgO properly increases surface compressive stress of chemically strengthened glass obtained after ion exchange, but reduces a depth of a compressive stress layer. Based on this, a mole percentage of MgO in the yttrium aluminosilicate glass in this application is preferably 10-35%. In addition, to meet glass properties of the yttrium aluminosilicate glass, a mole percentage of Al₂O₃+MgO+Y₂O₃ in the yttrium aluminosilicate glass in this application is preferably 40%≤Al₂O₃+MgO+Y₂O₃≤60%.

A function of B₂O₃ in the glass is to reduce a melting temperature and improve a forming property of the glass. B₂O₃ in the glass has two existence forms: a [BO₃]trihedron and a [BO₄]tetrahedron. When the glass includes both Al₂O₃ and B₂O₃, Na⁺ preferentially performs charge compensation for a [AlO₄]tetrahedron, and superfluous Na⁺ performs charge compensation for [BO₄] to form a tetrahedron. Otherwise, B₂O₃ exists in a form of a [BO₃]trihedron. Based on this, to meet a property requirement, a mole percentage of B₂O₃ in the yttrium aluminosilicate glass in this application is preferably 2-10%.

As a common nucleation agent, ZrO₂ has relatively high content. This helps improve a Young's modulus and Vickers hardness. However, solubility of ZrO₂ in the glass is limited, and excessively high content causes devitrification of the glass. Based on this, to meet a property requirement, a mole percentage of ZrO₂ in the yttrium aluminosilicate glass provided in this application is preferably 1-15%. Further, properties such as average hardness, fracture strength, and fracture toughness of the manufactured yttrium aluminosilicate glass are improved, to adjust properties such as scratch resistance and drop resistance of the glass. In addition, ZrO₂ in the yttrium aluminosilicate glass in this application can deflect a microcrack propagation path, so that drop resistance of the glass is further improved. It may also be learned from property detection parameters of the yttrium aluminosilicate glass in subsequent embodiments that the yttrium aluminosilicate glass in embodiments of this application has higher Vickers hardness and better fracture toughness.

The alkali metal oxide Na₂O is a main network modifier and is also a main participant in ion exchange. Content of Na₂O in the glass system not only greatly affects the network structure of the glass, but also greatly affects an ion exchange process. As described above, when the content of Na₂O is small, a cation with high field strength (for example, Li⁺, B³⁺, or Be²⁺) interferes with an ion exchange effect. Therefore, the content of ZrO₂ needs to have an appropriate interval. Based on this, to meet a chemical strengthening requirement, a mole percentage of Li₂O+Na₂O+K₂O in the yttrium aluminosilicate glass in this application is preferably 0.3%≤Li₂O+Na₂O+K₂O≤15%. A mole percentage of Li₂O+Na₂O is preferably 4%≤Li₂O+Na₂O≤37%, and a mole percentage of K₂O is preferably 0.1-15%. Therefore, after chemical strengthening is performed on the yttrium aluminosilicate glass in embodiments of this application, chemically strengthened glass with better properties such as surface hardness, flexural strength, and fracture toughness can be obtained.

In some implementations of this application, the yttrium aluminosilicate glass may further include a clarifying agent, for example, Sb₂O₃. Sb₂O₃ may be decomposed at a high temperature in a glass melting process, and gas is generated through gasification or viscosity of molten glass is reduced, so that bubbles in the molten glass are eliminated. In addition, during preparation, the glass presents light yellow due to an internal vacancy defect. A coloring problem of the glass can be resolved by adding Sb₂O₃, so that the glass is colorless and transparent. Based on this, to meet a property requirement, a mole percentage of Sb₂O₃ in the yttrium aluminosilicate glass in this application is preferably 0.1-10%. Further, a better melting effect can be achieved by adding Sb₂O₃.

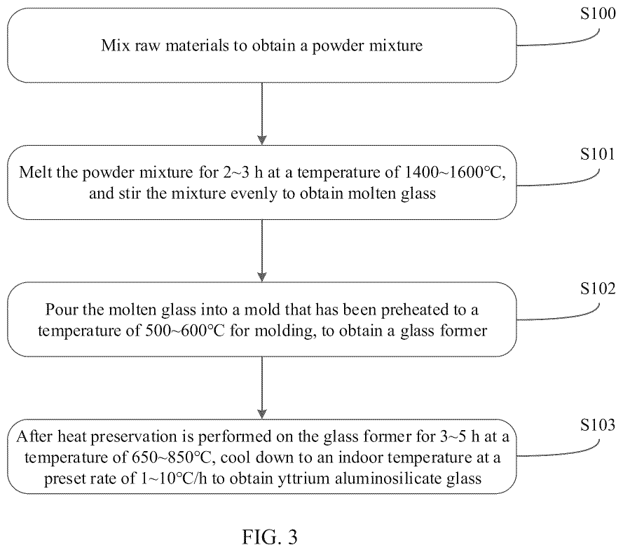

This application further provides a preparation method for the foregoing yttrium aluminosilicate glass. Refer to FIG. 3. The method specifically includes the following steps S100 to S103.

S100: Mix raw materials to obtain a powder mixture.

S101: Melt the powder mixture for 2-3 h at a temperature of 1400-1600° C., and stir the mixture evenly to obtain molten glass.

S102: Pour the molten glass into a mold that has been preheated to a temperature of 500-600° C. for molding, to obtain a glass former.

S103: After heat preservation is performed on the glass former for 3-5 h at a temperature of 650-850° C., cool down to an indoor temperature at a preset rate of 1-10° C./h to obtain yttrium aluminosilicate glass.

In some implementations of this application, components of the raw materials include SiO₂, Al₂O₃, MgO, Y₂O₃, TiO₂, ZrO₂, Na₂O, Li₂O, K₂O, B₂O₃, BaO, SrO, Sb₂O₃, and La₂O₃. It should be noted that the raw materials may be mixed based on the foregoing configuration.

It should be noted that, in this application, components of the foregoing raw materials and the manufactured yttrium aluminosilicate glass are all represented by a reference mole percentage of an oxide. However, in an actual preparation process, the raw material may be another form of material including the foregoing oxide. Therefore, a finally obtained oxide needs only to meet a configuration condition of the foregoing oxide.

In an implementation, for representation by a mass ratio of the yttrium aluminosilicate glass, the raw materials may include: 19.08 g SiO₂, 24.46 g Al₂O₃, 8.06 g MgO, 22.57 g Y₂O₃, 2.00 g TiO₂, 4.31 g ZrO₂, 6.36 g Na₂CO₃, 1.48 g Li₂CO₃, 0.69 g K₂CO₃, 1.79 g H₃BO₃, 1.38 g BaCO₃, 0.15 g SrCO₃, 0.33 g La₂O₃, and 0.29 g Sb₂O₃.

In some implementations of this application, after the raw materials are accurately weighed, the raw materials are placed in a drum-type ball mill for full grinding and even mixing, to obtain the powder mixture. Then, the powder mixture is heated at a high temperature and molten. After the powder mixture is molten, the mechanical mixture of the raw materials is converted into a complex melt, that is, the molten glass. After the molten glass is obtained, the molten glass needs to be molded in the mold to obtain the glass former. It should be noted that a production process of the glass former is a process of converting the molten glass into a product with a geometric shape. Finally, the glass former is annealed. Annealing mainly means that the glass former is placed in an annealing kiln, and is cooled down at a low speed after specific time, to reduce or eliminate, as much as possible, thermal stress generated in the glass. In the preparation method provided in this application, an appropriate quantity of alkali metal oxides and glass formers are introduced to reduce a glass melting temperature, and further improve a glass forming capability.

In addition, the yttrium aluminosilicate glass provided in this application may also be used in fields such as building and transportation. For example, the yttrium aluminosilicate glass may be used in a building material as a glass window, a glass countertop, or the like, or may be used in transportation equipment as a window of a transportation vehicle (a car, a train, a plane, or the like).

To better understand the technical solutions and technical effects of this application, the following further describes 11 embodiments. In different embodiments, components of the yttrium aluminosilicate glass are different. For details, refer to Table 2. Content of each component is represented by a mole percentage (mol %).

TABLE 2

| Component | Embodi- | Embodi- | Embodi- | Embodi- | Embodi- | Embodi- | Embodi- | Embodi- | Embodi- | Embodi- | Embodi- |
|---|---|---|---|---|---|---|---|---|---|---|---|
| (mol %) | ment 1 | ment 2 | ment 3 | ment 4 | ment 5 | ment 6 | ment 7 | ment 8 | ment 9 | ment 10 | ment 11 |
| SiO₂ | 20 | 20 | 20 | 21 | 21 | 29 | 30 | 40 | 50 | 50 | 20 |
| Al₂O₃ | 15 | 40 | 16 | 16 | 16 | 24 | 15 | 16 | 15 | 15 | 40 |
| MgO | 10 | 10 | 11 | 11 | 11 | 20 | 35 | 12 | 10 | 10 | 10 |
| Y₂O₃ | 5 | 5 | 35 | 6 | 6 | 10 | 5 | 10 | 5 | 5 | 5 |
| TiO₂ | 10 | 2 | 1 | 15 | 1 | 2.5 | 0.1 | 1 | 1 | 1 | 2 |
| ZrO₂ | 10 | 2 | 2 | 15 | 1 | 3.5 | 0.1 | 1 | 2 | 2 | 2 |
| Na₂O | 7 | 5 | 2 | 5 | 15 | 6 | 2 | 2 | 3.5 | 3.5 | 0.1 |
| Li₂O | 6 | 3 | 2 | 4 | 15 | 2 | 1 | 1 | 3 | 0.1 | 3 |
| K₂O | 5 | 2 | 0.2 | 1 | 7 | 0.5 | 1 | 15 | 0.1 | 3 | 2 |
| B₂O₃ | 5.9 | 0.5 | 10 | 1 | 1.6 | 1.5 | 0.5 | 0.7 | 0.1 | 0.1 | 0.5 |
| BaO | 3.9 | 0.1 | 0.2 | 1 | 2 | 0.7 | 10 | 1 | 0.1 | 0.1 | 5 |
| SrO | 2 | 0.1 | 0.3 | 3.8 | 3 | 0.1 | 0.1 | 0.1 | 10 | 10 | 0.1 |
| La₂O₃ | 0.1 | 10 | 0.1 | 0.1 | 0.2 | 0.1 | 0.1 | 0.1 | 0.1 | 0.1 | 10 |
| Sb₂O₃ | 0.1 | 0.3 | 0.2 | 0.1 | 0.2 | 0.1 | 0.1 | 0.1 | 0.1 | 0.1 | 0.3 |

It should be noted that an yttrium aluminosilicate glass preparation method in each embodiment may be the foregoing preparation method, and details are not described herein again.

### Embodiment 1

For components of raw materials, refer to Table 2. A specific preparation process is as follows:

S111: SiO₂, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 12.01 g SiO₂, 15.29 g Al₂O₃, 4.03 g MgO, 11.29 g Y₂O₃, 7.98 g TiO₂, 12.32 g ZrO₂, 7.42 g Na₂CO₃, 4.44 g Li₂CO₃, 6.91 g K₂CO₃, 7.06 g H₃BO₃, 7.69 g BaCO₃, 2.95 g SrCO₃, 0.33 g La₂O₃, and 0.29 g Sb₂O₃. The raw materials are placed in a drum-type ball mill for full grinding and even mixing to obtain a powder mixture.

S112: Melt the powder mixture for 2 h at a temperature of 1520° C., and stir the mixture evenly to obtain even molten glass.

S113: Pour the molten glass into a mold that has been preheated to a temperature of 550° C. for molding, to obtain a glass former.

S114: After heat preservation is performed on the glass former for 2 h at a temperature of 690° C., cool down to an indoor temperature at a preset rate of 3° C./h, to obtain yttrium aluminosilicate glass.

### Embodiment 2

For components of raw materials, refer to Table 2. A specific preparation process is as follows:

S211: SiO₂, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 10.28 g SiO₂, 40.77 g Al₂O₃, 4.03 g MgO, 11.29 g Y₂O₃, 1.60 g TiO₂, 2.46 g ZrO₂, 5.30 g Na₂CO₃, 2.22 g Li₂CO₃, 2.76 g K₂CO₃, 0.60 g H₃BO₃, 0.2 g BaCO₃, 0.15 g SrCO₃, 32.57 g La₂O₃, and 0.87 g Sb₂O₃. The raw materials are placed in a drum-type ball mill for full grinding and even mixing to obtain a powder mixture.

S212: Melt the powder mixture for 3 h at a temperature of 1600° C., and stir the mixture evenly to obtain even molten glass.

S213: Pour the molten glass into a mold that has been preheated to a temperature of 550° C. for molding, to obtain a glass former.

S214: After heat preservation is performed on the glass former for 3 h at a temperature of 720° C., cool down to an indoor temperature at a preset rate of 1° C./h to obtain yttrium aluminosilicate glass.

### Embodiment 3

For components of raw materials, refer to Table 2. A specific preparation process is as follows:

S311: SiO₂, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 9.06 g SiO₂, 16.31 g Al₂O₃, 4.43 g MgO, 79.00 g Y₂O₃, 0.80 g TiO₂, 2.46 g ZrO₂, 2.12 g Na₂CO₃, 1.48 g Li₂CO₃, 0.28 g K₂CO₃, 11.96 g H₃BO₃, 0.39 g BaCO₃, 0.44 g SrCO₃, 0.33 g La₂O₃, and 0.58 g Sb₂O₃. The raw materials are placed in a drum-type ball mill for full grinding and even mixing to obtain a powder mixture.

S312: Melt the powder mixture for 3 h at a temperature of 1550° C., and stir the mixture evenly to obtain even molten glass.

S313: Pour the molten glass into a mold that has been preheated to a temperature of 550° C. for molding, to obtain a glass former.

S314: After heat preservation is performed on the glass former for 3 h at a temperature of 710° C., cool down to an indoor temperature at a preset rate of 1° C./h to obtain yttrium aluminosilicate glass.

### Embodiment 4

For components of raw materials, refer to Table 2. A specific preparation process is as follows:

S411: SiO₂, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 13.09 g SiO₂, 16.31 g Al₂O₃, 4.43 g MgO, 13.54 g Y₂O₃, 11.98 g TiO₂, 18.48 g ZrO₂, 5.30 g Na₂CO₃, 2.96 g Li₂CO₃, 1.38 g K₂CO₃, 1.20 g H₃BO₃, 1.97 g BaCO₃, 5.61 g SrCO₃, 0.33 g La₂O₃, and 0.29 g Sb₂O₃. The raw materials are placed in a drum-type ball mill for full grinding and even mixing to obtain a powder mixture.

S412: Melt the powder mixture for 2 h at a temperature of 1550° C., and stir the mixture evenly to obtain even molten glass.

S413: Pour the molten glass into a mold that has been preheated to a temperature of 550° C. for molding, to obtain a glass former.

S414: After heat preservation is performed on the glass former for 3 h at a temperature of 700° C., cool down to an indoor temperature at a preset rate of 1° C./h to obtain yttrium aluminosilicate glass.

### Embodiment 5

For components of raw materials, refer to Table 2. A specific preparation process is as follows:

S511: SiO₂, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 12.99 g SiO₂, 16.31 g Al₂O₃, 4.43 g MgO, 13.54 g Y₂O₃, 0.80 g TiO₂, 1.23 g ZrO₂, 15.89 g Na₂CO₃, 11.10 g Li₂CO₃, 9.67 g K₂CO₃, 1.91 g H₃BO₃, 3.95 g BaCO₃, 4.43 g SrCO₃, 0.65 g La₂O₃, and 0.58 g Sb₂O₃. The raw materials are placed in a drum-type ball mill for full grinding and even mixing to obtain a powder mixture.

S512: Melt the powder mixture for 3 h at a temperature of 1550° C., and stir the mixture evenly to obtain even molten glass.

S513: Pour the molten glass into a mold that has been preheated to a temperature of 550° C. for molding, to obtain a glass former.

S514: After heat preservation is performed on the glass former for 3 h at a temperature of 710° C., cool down to an indoor temperature at a preset rate of 4° C./h to obtain yttrium aluminosilicate glass.

### Embodiment 6

For components of raw materials, refer to Table 2. A specific preparation process is as follows:

S611: S102, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 19.08 g SiO₂, 24.46 g Al₂O₃, 8.06 g MgO, 22.57 g Y₂O₃, 2.00 g TiO₂, 4.31 g ZrO₂, 6.36 g Na₂CO₃, 1.48 g Li₂CO₃, 0.69 g K₂CO₃, 1.79 g H₃BO₃, 1.38 g BaCO₃, 0.15 g SrCO₃, 0.33 g La₂O₃, and 0.29 g Sb₂O₃. The raw materials are placed in a drum-type ball mill for full grinding and even mixing to obtain a powder mixture.

S612: Melt the powder mixture for 2 h at a temperature of 1560° C., and stir the mixture evenly to obtain even molten glass.

S613: Pour the molten glass into a mold that has been preheated to a temperature of 550° C. for molding, to obtain a glass former.

S614: After heat preservation is performed on the glass former for 2 h at a temperature of 720° C., cool down to an indoor temperature at a preset rate of 5° C./h to obtain yttrium aluminosilicate glass.

### Embodiment 7

For components of raw materials, refer to Table 2. A specific preparation process is as follows:

S711: S102, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 21.39 g SiO₂, 15.29 g Al₂O₃, 14.10 g MgO, 11.29 g Y₂O₃, 0.08 g TiO₂, 0.12 g ZrO₂, 2.12 g Na₂CO₃, 0.74 g Li₂CO₃, 1.38 g K₂CO₃, 0.60 g H₃BO₃, 19.73 g BaCO₃, 0.15 g SrCO₃, 0.33 g La₂O₃, and 0.29 g Sb₂O₃. The raw materials are placed in a drum-type ball mill for full grinding and even mixing to obtain a powder mixture.

S712: Melt the powder mixture for 3 h at a temperature of 1560° C., and stir the mixture evenly to obtain even molten glass.

S713: Pour the molten glass into a mold that has been preheated to a temperature of 550° C. for molding, to obtain a glass former.

S714: After heat preservation is performed on the glass former for 2 h at a temperature of 720° C., cool down to an indoor temperature at a preset rate of 5° C./h to obtain yttrium aluminosilicate glass.

### Embodiment 8

For components of raw materials, refer to Table 2. A specific preparation process is as follows:

S811: SiO₂, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 24.79 g SiO₂, 16.31 g Al₂O₃, 4.83 g MgO, 22.57 g Y₂O₃, 0.80 g TiO₂, 1.23 g ZrO₂, 2.12 g Na₂CO₃, 0.74 g Li₂CO₃, 20.72 g K₂CO₃, 0.84 g H₃BO₃, 1.97 g BaCO₃, 0.15 g SrCO₃, 0.33 g La₂O₃, and 0.29 g Sb₂O₃. The raw materials are placed in a drum-type ball mill for full grinding and even mixing to obtain a powder mixture.

S812: Melt the powder mixture for 3 h at a temperature of 1540° C., and stir the mixture evenly to obtain even molten glass.

S813: Pour the molten glass into a mold that has been preheated to a temperature of 550° C. for molding, to obtain a glass former.

S814: After heat preservation is performed on the glass former for 2 h at a temperature of 710° C., cool down to an indoor temperature at a preset rate of 10° C./h to obtain yttrium aluminosilicate glass.

### Embodiment 9

For components of raw materials, refer to Table 2. A specific preparation process is as follows:

S911: SiO₂, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 35.06 g SiO₂, 15.29 g Al₂O₃, 4.03 g MgO, 11.29 g Y₂O₃, 0.80 g TiO₂, 2.46 g ZrO₂, 3.71 g Na₂CO₃, 2.22 g Li₂CO₃, 0.14 g K₂CO₃, 0.12 g H₃BO₃, 0.20 g BaCO₃, 14.76 g SrCO₃, 0.33 g La₂O₃, and 0.29 g Sb₂O₃. The raw materials are placed in a drum-type ball mill for full grinding and even mixing to obtain a powder mixture.

S912: Melt the powder mixture for 2 h at a temperature of 1540° C., and stir the mixture evenly to obtain even molten glass.

S913: Pour the molten glass into a mold that has been preheated to a temperature of 600° C. for molding, to obtain a glass former.

S914: After heat preservation is performed on the glass former for 2 h at a temperature of 710° C., cool down to an indoor temperature at a preset rate of 3° C./h to obtain yttrium aluminosilicate glass.

### Embodiment 10

For components of raw materials, refer to Table 2. A specific preparation process is as follows:

S1011: SiO₂, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 30.04 g SiO₂, 15.29 g Al₂O₃, 4.03 g MgO, 11.29 g Y₂O₃, 0.80 g TiO₂, 2.46 g ZrO₂, 3.71 g Na₂CO₃, 0.07 g Li₂CO₃, 4.15 g K₂CO₃, 0.12 g H₃BO₃, 0.20 g BaCO₃, 14.76 g SrCO₃, 0.19 g La₂O₃, and 0.29 g Sb₂O₃.

S1012: Melt the powder mixture for 2.5 h at a temperature of 1540° C., and stir the mixture evenly to obtain even molten glass.

S1013: Pour the molten glass into a mold that has been preheated to a temperature of 600° C. for molding, to obtain a glass former.

S1014: After heat preservation is performed on the glass former for 6 h at a temperature of 700° C., cool down to an indoor temperature at a preset rate of 5° C./h to obtain yttrium aluminosilicate glass.

### Embodiment 11

For components of raw materials, refer to Table 2. A specific preparation process is as follows:

S1111: S102, Al₂O₃, MgO, Y₂O₃, TiO₂, ZrO₂, Na₂CO₃, Li₂CO₃, K₂CO₃, H₃BO₃, BaCO₃, SrCO₃, La₂O₃, and Sb₂O₃ are mainly used as raw materials. The raw materials are weighted and taken based on the following masses: 12.02 g SiO₂, 40.79 g Al₂O₃, 4.03 g MgO, 11.29 g Y₂O₃, 1.6 g TiO₂, 2.46 g ZrO₂, 0.11 g Na₂CO₃, 2.22 g Li₂CO₃, 2.76 g K₂CO₃, 0.62 g H₃BO₃, 9.87 g BaCO₃, 14.76 g SrCO₃, 16.69 g La₂O₃, and 0.29 g Sb₂O₃.

S1112: Melt the powder mixture for 5 h at a temperature of 1530° C., and stir the mixture evenly to obtain even molten glass.

S1113: Pour the molten glass into a mold that has been preheated to a temperature of 650° C. for molding, to obtain a glass former.

S1114: After heat preservation is performed on the glass former for 2 h at a temperature of 750° C., cool down to an indoor temperature at a preset rate of 4° C./h to obtain yttrium aluminosilicate glass.

Property comparison is performed on the yttrium aluminosilicate glass made in the foregoing Embodiment 1 to Embodiment 11. Property test items include: Vickers hardness, a Young's modulus, Mohs hardness, and a light transmittance.

A test result is shown in Table 3.

TABLE 3

| | Vickers | Young's | |
|---|---|---|---|
| Test item | hardness | modulus | Mohs hardness |
| Embodiment 1 | 7.65 GPa | 122.56 GPa | Greater than 7 and |
| | | | less than 8 |
| Embodiment 2 | 7.61 GPa | 130.34 GPa | Greater than 7 and |
| | | | less than 8 |
| Embodiment 3 | 7.85 GPa | 125.55 GPa | Greater than 7 and |
| | | | less than 8 |
| Embodiment 4 | 7.95 GPa | 127.65 GPa | Greater than 7 and |
| | | | less than 8 |
| Embodiment 5 | 8.34 GPa | 130.65 GPa | Greater than 7 and |
| | | | less than 8 |
| Embodiment 6 | 8.63 GPa | 140.65 GPa | Greater than 8 and |
| | | | less than 9 |
| Embodiment 7 | 9.35 GPa | 160.00 GPa | Greater than 8 and |
| | | | less than 9 |
| Embodiment 8 | 6.87 GPa | 120.00 GPa | Greater than 7 and |
| | | | less than 8 |
| Embodiment 9 | 8.73 GPa | 132.12 GPa | Greater than 8 and |
| | | | less than 9 |
| Embodiment 10 | 8.779 GPa | 136.77 GPa | Greater than 8 and |
| | | | less than 9 |
| Embodiment 11 | 8.642 GPa | 129.12 GPa | Greater than 8 and |
| | | | less than 9 |

It can be learned from the test result in Table 3 that the Young's modulus of the yttrium aluminosilicate glass provided in this application is greater than 100 GPa, and is preferably greater than 160 GPa. The Vickers hardness is greater than 6.87 GPa, and is preferably greater than 9.35 GPa. The Mohs hardness is greater than or equal to 7 and less than or equal to 9. The yttrium aluminosilicate glass manufactured by adding oxide content with a high bulk density, a high elastic modulus coefficient, and a high specific modulus coefficient to a silicate system has high Vickers hardness, high Mohs hardness, and a high Young's modulus. Therefore, a structure density and strength of the glass are improved, and a penetration depth of a sharp object can be reduced. In addition, compressive stress introduced by the yttrium aluminosilicate glass through ion exchange in embodiments of this application can suppress crack propagation. This further improves drop resistance of the glass.

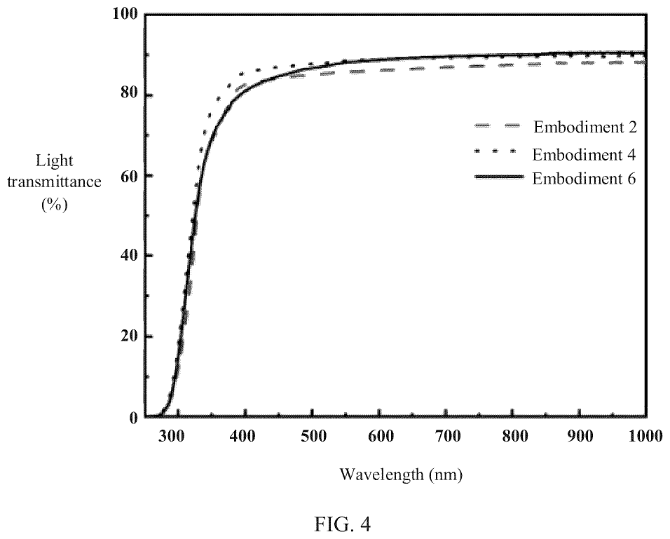

In some implementations of this application, the yttrium aluminosilicate glass is transparent in a visible light band, and has a high transmittance. FIG. 4 shows light transmittance curves of yttrium aluminosilicate glass according to Embodiment 2, Embodiment 4, and Embodiment 6 of this application. Refer to FIG. 4. In Embodiment 2, Embodiment 4, and Embodiment 6, a light transmittance of yttrium aluminosilicate glass in a visible light band (380 nm-780 nm) reaches 88% or more, so that an application requirement in fields such as a display of an electronic device can be met.

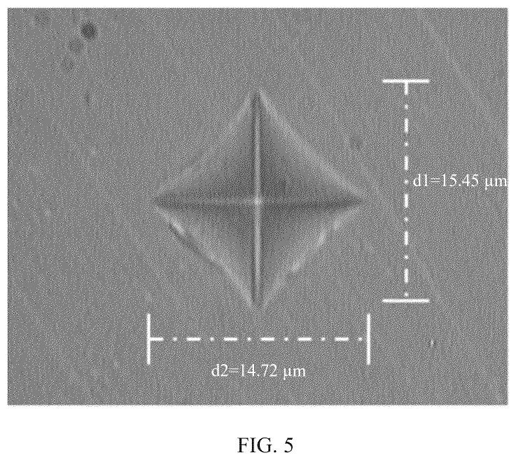

FIG. 5 is a diagram of a test on Vickers hardness of yttrium aluminosilicate glass according to Embodiment 7 of this application. Refer to FIG. 5. Lengths of diagonals of an indentation on a surface of the yttrium aluminosilicate glass in Embodiment 7 are respectively: d1=15.45 μm and d2=14.72 μm. Then, it is learned that an average length of the diagonals of the indentation is d=15.085 μm. The obtained average length d of the diagonals of the indentation is substituted into a first formula to calculate Vickers hardness, and obtained Vickers hardness is 7.65 GPa. The first formula is as follows:

$$Hv = \frac{2 P sin θ}{{d}^{2}} \qquad ( 1 )$$

Hv is the Vickers hardness; P is applied load; dis the average length of the diagonals of the indentation; and θ=136°.

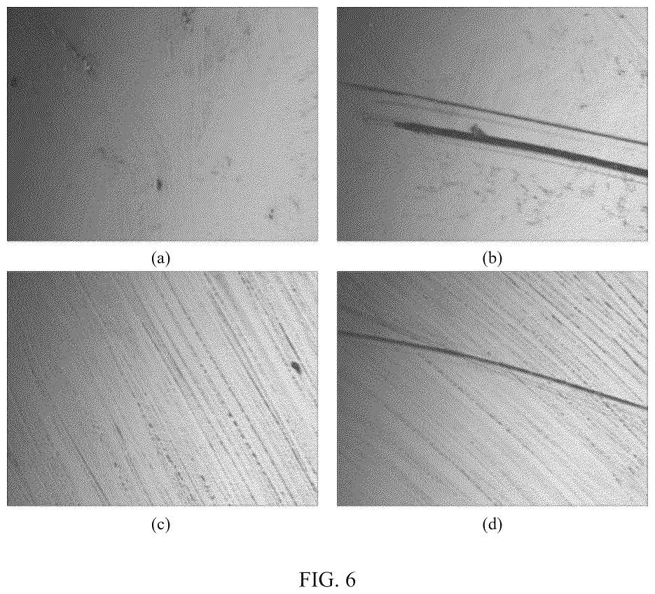

a in FIG. 6 is a micrograph of Mohs hardness-based scratches on yttrium aluminosilicate glass according to Embodiment 1 of this application. Refer to a in FIG. 6. In this application, a Mohs hardness test is performed on the yttrium aluminosilicate glass in Embodiment 1 by using a level-7 Mohs hardness pen, and it can be learned that there is no scratch on a surface of the yttrium aluminosilicate glass in Embodiment 1.

b in FIG. 6 is a micrograph of Mohs hardness-based scratches on yttrium aluminosilicate glass according to Embodiment 1 of this application. Refer to b in FIG. 6. In this application, a Mohs hardness test is performed on the yttrium aluminosilicate glass in Embodiment 1 by using a level-8 Mohs hardness pen, and it can be learned that there are scratches on a surface of the yttrium aluminosilicate glass in Embodiment 1. Therefore, Mohs hardness of the yttrium aluminosilicate glass in Embodiment 1 is greater than 7 and less than 8.

c in FIG. 6 is a micrograph of Mohs hardness-based scratches on yttrium aluminosilicate glass according to Embodiment 6 of this application. Refer to c in FIG. 6. In this application, a Mohs hardness test is performed on the yttrium aluminosilicate glass in Embodiment 6 by using a level-8 Mohs hardness pen, and it can be learned that there is no scratch on a surface of the yttrium aluminosilicate glass in Embodiment 6.

d in FIG. 6 is a micrograph of Mohs hardness-based scratches on yttrium aluminosilicate glass according to Embodiment 6 of this application. Refer to d in FIG. 6. In this application, a Mohs hardness test is performed on the yttrium aluminosilicate glass in Embodiment 6 by using a level-9 Mohs hardness pen, and it can be learned that there are scratches on a surface of the yttrium aluminosilicate glass in Embodiment 6. Therefore, Mohs hardness of the yttrium aluminosilicate glass in Embodiment 6 is greater than 8 and less than 9.

It may be understood that various numbers in embodiments of this application are merely used for differentiation for ease of description, and are not used to limit the scope of embodiments of this application. It may be understood that in embodiments of this application, sequence numbers of processes do not mean a sequence of execution. The sequence of execution of the processes should be determined according to functions and internal logic of the processes, and should not constitute any limitation on an implementation process of embodiments of this application.

The foregoing embodiments are merely used to describe the technical solutions of this application, but not limit the technical solutions of this application. Although this application is described in detail with reference to the foregoing embodiments, persons of ordinary skill in the art should understand that they may still modify the technical solutions described in the foregoing embodiments, or perform equivalent replacement on some technical features. However, these modifications or replacements do not make the essence of the corresponding technical solutions depart from the spirit and scope of the technical solutions in embodiments of this application.

1. Yttrium aluminosilicate glass, wherein for representation by a reference mole percentage of an oxide, the yttrium aluminosilicate glass comprises the following components:
SiO₂ 20-50%;
Al₂O₃ 15-40%;
MgO 10-35%;
Y₂O₃ 5-35%;
TiO₂ 0.1-15%;
ZrO₂ 0.1-15%;
Na₂O 0.1-15%;
Li₂O 0.1-15%;
K₂O 0.1-15%;
B₂O₃ 0.1-10%;
BaO 0.1-10%;
SrO 0.1-10%;
Sb₂O₃ 0.1-10%; and
La₂O₃ 0.1-10%.

2. The yttrium aluminosilicate glass according to claim 1, wherein for representation by a reference mole percentage of an oxide, 0.3%≤Li₂O+Na₂O+K₂O≤15%.

3. The yttrium aluminosilicate glass according to claim 1, wherein for representation by a reference mole percentage of an oxide, 40%≤Al₂O₃+MgO+Y₂O₃≤60%.

4. The yttrium aluminosilicate glass according to claim 1, wherein for representation by a reference mole percentage of an oxide, a mole percentage of ZrO₂ is 1-15%.

5. The yttrium aluminosilicate glass according to claim 1, wherein for representation by a reference mole percentage of an oxide, a mole percentage of B₂O₃ is 2-10%.

6. The yttrium aluminosilicate glass according to claim 1, wherein a light transmittance of the yttrium aluminosilicate glass in a visible light band is greater than or equal to 88%.

7. The yttrium aluminosilicate glass according to claim 1, wherein a Young's modulus of the yttrium aluminosilicate glass is greater than 100 GPa.

8. The yttrium aluminosilicate glass according to claim 1, wherein Vickers hardness of the yttrium aluminosilicate glass is greater than 6.87 GPa.

9. The yttrium aluminosilicate glass according to claim 1, wherein Mohs hardness of the yttrium aluminosilicate glass is greater than or equal to 7 and less than or equal to 9.

10. An yttrium aluminosilicate glass preparation method, the method comprising:
mixing raw materials required for meeting the yttrium aluminosilicate glass according to claim 1, to obtain a powder mixture after mixing;
melting the powder mixture for 2 to 3 hours at a temperature of 1400 to 1600° C., and stirring the mixture evenly to obtain molten glass;
pouring the molten glass into a preheated mold for molding to obtain a glass former; and
after heat preservation is performed on the glass former for 3 to 5 hours at a temperature of 650 to 850° C., cooling down to an indoor temperature at a preset rate to obtain the yttrium aluminosilicate glass.

11. The method according to claim 10, wherein a temperature of the mold is 500 to 600° C.

12. The method according to claim 11, wherein the preset rate is 1 to 10° C./h.

13. The method according to claim 12, wherein for representation by a mass ratio of the yttrium aluminosilicate glass, the raw materials comprise: 19.08 g SiO₂, 24.46 g Al₂O₃, 8.06 g MgO, 22.57 g Y₂O₃, 2.00 g TiO₂, 4.31 g ZrO₂, 6.36 g Na₂CO₃, 1.48 g Li₂CO₃, 0.69 g K₂CO₃, 1.79 g H₃BO₃, 1.38 g BaCO₃, 0.15 g SrCO₃, 0.33 g La₂O₃, and 0.29 g Sb₂O₃.

14. The method according to claim 13, further comprising:
melting the powder mixture for 2 hours at a temperature of 1560° C., and stirring the mixture evenly to obtain the molten glass;
pouring the molten glass into the preheated mold that has been preheated to a temperature of 550° C. for molding to obtain the glass former; and
after heat preservation is performed on the glass former for 2 hours at a temperature of 720° C., cooling down to the indoor temperature at a preset rate of 5° C./h to obtain the yttrium aluminosilicate glass.

15. (canceled)

16. An electronic device, comprising a display cover plate, wherein the display cover plate comprises the yttrium aluminosilicate glass according to claim 1.

17. The electronic device according to claim 16, further comprising a rear battery cover, wherein the rear battery cover comprises the yttrium aluminosilicate glass according to claim 1.

18. The electronic device according to claim 16, further comprising a camera component and a camera protection cover plate, wherein the camera protection cover plate covers the camera component, and the camera protection cover plate comprises the yttrium aluminosilicate glass according to claim 1.

19. The yttrium aluminosilicate glass according to claim 2, wherein for representation by a reference mole percentage of an oxide, 40%≤Al₂O₃+MgO+Y₂O₃≤60%.

20. The yttrium aluminosilicate glass according to claim 19, wherein for representation by a reference mole percentage of an oxide, a mole percentage of ZrO₂ is 1-15%.

21. The yttrium aluminosilicate glass according to claim 19, wherein for representation by a reference mole percentage of an oxide, a mole percentage of B₂O₃ is 2-10%.
